(19) United States
(12) Patent Application Publication
(10) Pub. No.: US 2011/0255732 A1
(43) Pub. Date: Oct. 20, 2011

(54) MULTIFUNCTIONAL MICRO SPEAKER

(75) Inventors: Cheol-Young Kwon, Incheon (KR); Sang-Ho Lee, Incheon (KR); Hong-Kyu Jang, Seoul (KR)

(73) Assignee: BSE CO., LTD., Incheon (KR)

(21) Appl. No.: 13/140,966

(22) PCT Filed: Nov. 4, 2009
(86) PCT No.: PCT/KR2009/006439

§ 371 Date: Jun. 20, 2011

(30) Foreign Application Priority Data
Sep. 4, 2009 (KR) 20-2009-0011648

(51) Int. Cl. H04R 9/06

(52) U.S. Cl. 381/396

(57) ABSTRACT

A multifunctional micro speaker including a frame; a diaphragm having an outer circumferential portion fixed to the frame; a voice coil fixed to a lower surface of the diaphragm; a first suspension having an outer circumferential portion fixed to the frame and having a predetermined elasticity; a yoke fixed to the first suspension; a first permanent magnet fixed to a bottom surface of the yoke; a plate fixed to an upper surface of the first permanent magnet; a second suspension including a supporter and a protrusion, and having a predetermined elasticity, wherein the supporter is spaced apart from the first suspension in a downwards direction and has a first end portion fixed to the frame, and the protrusion protrudes from the supporter towards the first suspension; and a second magnet accommodated in the protrusion and fixed to a lower surface of the second suspension.

### CROSS-REFERENCE TO RELATED PATENT APPLICATION

This application claims the benefit of Korean Patent Applications No. 20-2009-0011648, filed on Sep. 4, 2009, in the Korean Intellectual Property Office, and the benefit of International Patent Application No. PCT/KR2009/006439, filed on Nov. 4, 2009, in the Korean Intellectual Property Office, the disclosures of which are incorporated herein in their entirety by reference.

### BACKGROUND OF THE INVENTION

1. Field of the Invention

One or more aspects of the present invention relate to a multifunctional micro speaker, and more particularly, to a multifunctional micro speaker including a yoke, a first permanent magnet, and a plate, which constitute a speaker magnetic circuit due to an attractive force between the first permanent magnet and a second magnet included in a vibrator, thereby preventing the yoke, the first permanent magnet, and the plate from drooping downwards.

2. Description of the Related Art

A multifunctional micro speaker as claimed in the present application has been invented by improving a multifunctional micro speaker disclosed in Korean Utility Model Application No. 2009-10878 filed by the present applicant.

A speaker is a device for converting an electrical signal into a voice signal. A micro speaker is a small-sized speaker used in small-sized portable audio devices such as cellular phones, notebook computers, MP3 players, earphones, and the like. Demand for such devices has risen sharply recently.

However, conventional electrical products employing a micro speaker, in particular, mobile communication devices such as cellular phones, include a component for generating a vibration. Vibration is frequently used instead of a sound to indicate an incoming call or an input state in a touch screen method in which information is input directly by touching a screen.

A multifunctional micro speaker as claimed in the present application further includes a component for generating a vibration, in addition to including a component for performing a basic function of generating a sound. A multifunctional micro speaker is variously referred to as a multifunctional actuator, a multifunctional electrical sound converter, or the like.

A conventional multifunctional micro speaker is configured to generate a vibration by making a vibrator supported by a plate-type spring resonate. The conventional multifunctional micro speaker includes a voice coil disposed in a magnetic circuit at a side of a diaphragm that is also referred to as a reed. Thus, when a voice signal current is supplied to the voice coil, a sound is output. In addition, when a vibration signal current is supplied to the voice coil, a vibration is generated in the vibrator.

FIG. 1 is a cross-sectional view of a multifunctional micro speaker 100 disclosed in Korean Utility Model Application No. 2009-10878 filed by the present applicant. Referring to FIG. 1, the multifunctional micro speaker 100 includes a frame 110, a diaphragm 101 for generating a sound, a voice coil 102, a first permanent magnet 104 of which N and S poles are vertically arranged, a plate 103, a yoke 105, a first suspension 107, a second suspension 108, and a second magnet 109. A current is supplied to the voice coil 102 through a lead wire (not shown).

An upper end portion of the voice coil 102 is fixed to a lower surface of the diaphragm 101. The voice coil 102 is vertically wound. The plate 103 is fixed to an upper surface of the first permanent magnet 104. The first permanent magnet 104 is fixed to a bottom surface of the yoke 105. The yoke 105 is fixed to the first suspension 107. The first suspension 107 is elastically supported against the frame 110. The yoke 105, the first permanent magnet 104, and the plate 103 constitute a speaker magnetic circuit.

The second suspension 108 is spaced apart from the first suspension 107 in a downward direction. An outer circumferential portion of the second suspension 108 is elastically supported by the frame 110. The second magnet 109 is fixed to a lower surface of the second suspension 108.

An operation of the multifunctional micro speaker 100 having the above-described structure will now be described. When a current appropriate for generating a sound is supplied to the voice coil 102 through a lead wire (not shown), an electromagnetic force is generated in the voice coil 102, and thus, the diaphragm 101 vibrates and a sound is output.

That is, a magnetic line of force emitted from the N pole of the first permanent magnet 104 forms a magnetic field oriented towards the S pole of the first permanent magnet 104 through the plate 103, the voice coil 102, and the yoke 105 in the order stated. In this case, when the electromagnetic force is generated in the voice coil 102, the electromagnetic force interacts with a magnetic flux generated due to the speaker magnetic circuit, and the diaphragm 101 fixed to the voice coil 102 vibrates, thereby functioning as a speaker for outputting a sound.

When a current (in general, a low frequency current) appropriate for a vibration is supplied to the voice coil 102, the second magnet 109 and the second suspension 108 move up and down to generate a vibration.

In the multifunctional micro speaker 100 having the above-described structure, when an attractive force acts between the first permanent magnet 104 and the second magnet 109, the yoke 105, the first permanent magnet 104, and the plate 103, which constitute the speaker magnetic circuit, may droop downwards.

That is, as shown in FIG. 2, the yoke 105, the first permanent magnet 104, and the plate 103, which constitute the speaker magnetic circuit, may droop downwards, and the second magnet 109 and the second suspension 108, which constitute a vibrator, may be bent upwards.

When the yoke 105, the first permanent magnet 104, and the plate 103 droop downwards, the voice coil 102 is not accurately positioned in a space between internal surfaces of the first permanent magnet 104 and the plate 103 and an internal surface of the yoke 105. The space between the internal surface of the first permanent magnet 104 and the plate 103 and the internal surface of the yoke 105 is referred to as a magnetic gap. The voice coil 102 needs to be positioned in the magnetic gap in order to facilitate an interaction between the speaker magnetic circuit and a current flowing through the voice coil 102. However, when the first suspension 107 droops downwards, the voice coil 102 may deviate from the magnetic gap, and thus, a sound level of a speaker may deteriorate.

### SUMMARY OF THE INVENTION

One or more aspects of the present invention provide a multifunctional micro speaker for preventing a yoke, a first permanent magnet, and a plate from drooping downwards.

According to an aspect of the present invention, there is provided a multifunctional micro speaker including a frame; a diaphragm having an outer circumferential portion fixed to the frame; a voice coil fixed to a lower surface of the diaphragm; a first suspension having an outer circumferential portion fixed to the frame and having a predetermined elasticity; a yoke fixed to the first suspension; a first permanent magnet fixed to a bottom surface of the yoke; a plate fixed to an upper surface of the first permanent magnet; a second suspension including a supporter and a protrusion, and having a predetermined elasticity, wherein the supporter is spaced apart from the first suspension in a downwards direction and has a first end portion fixed to the frame, and the protrusion protrudes from the supporter towards the first suspension; and a second magnet accommodated in the protrusion and fixed to a lower surface of the second suspension.

The protrusion may include a lateral wall portion extending upwards from a second end portion of the supporter, and a connection disposed in parallel to the first suspension.

The connection may have a disk shape.

In addition, a distance from a center of the connection 86 to the lateral wall portion may be greater than a distance from an inner circumference surface of the frame.

The lateral wall portion may vertically extend upwards from the second end portion of the supporter.

A lower surface of the second magnet may be positioned below the supporter.

In addition, a boss portion protruding upwards may be formed on a central portion of the first suspension. The yoke may include a yoke receiving groove to which the boss portion of the first suspension is coupled.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional multifunctional micro speaker

FIG. 2 is a cross-sectional view of a case where a first suspension of FIG. 1 droops downwards; and

FIG. 3 is a schematic cross-sectional view of a multifunctional micro speaker according to an embodiment of the present invention.

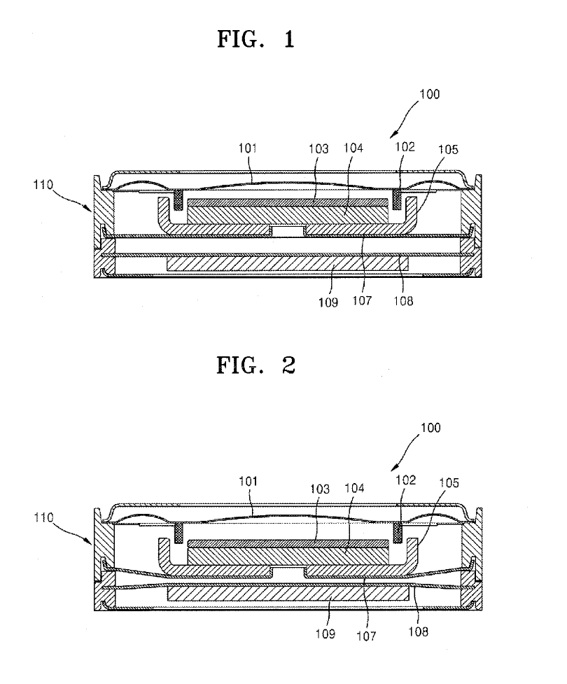

### DETAILED DESCRIPTION OF THE INVENTION

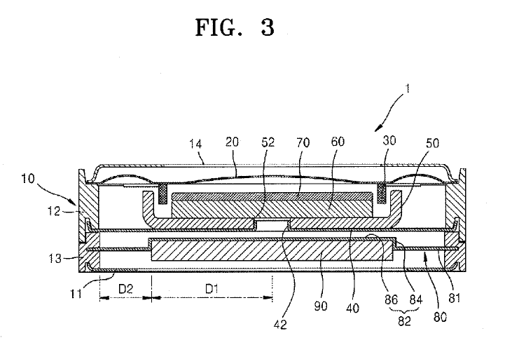

A multifunctional micro speaker according to an embodiment of the present invention will be described in detail with reference to the accompanying drawings. FIG. 3 is a schematic cross-sectional view of a multifunctional micro speaker 1 according to an embodiment of the present invention.

The multifunctional micro speaker 1 is mainly used in mobile communication devices such as cellular phones, or small-sized devices such as portable multimedia players (PMPs), and has both a function of generating a sound and a function of generating a vibration as a signal.

Referring to FIG. 3, the multifunctional micro speaker 1 includes a frame 10, a diaphragm 20, a voice coil 30, a first suspension 40, a yoke 50, a first permanent magnet 60, a plate 70, a second suspension 80, and a second magnet 90.

The frame 10 is generally formed of plastic and forms an outer appearance of the multifunctional micro speaker 1. Various components are fixed to an inner part of the frame 10. The frame 10 includes an upper frame 12, a lower frame 13, and a lower cover member 11. An upper cover member 14 is coupled to an upper portion of the upper frame 12. According to the present embodiment, the frame 10 has an overall cylindrical shape. According to another embodiment of the present invention, a cross section of the frame 10 may have a rectangular shape, an oval shape, or a track shape. In this case, internal components may be changed according to the shape of the cross-section.

An outer circumferential portion of the diaphragm 20 is fixed to an upper portion of the upper frame 12. The diaphragm 20 has a circular shape, and is generally formed of a high-molecular weight compound. The diaphragm 20 generates a sound pressure that is audible to human ears while vibrating vertically.

According to the present embodiment, the diaphragm 20 is divided into an inner portion and an outer portion, with respect to a boundary portion to which an upper end portion of the voice coil 30. Each of the inner portion and the outer portion has a dome shape. The boundary portion is flat. The outer portion is also referred to as an edge. The diaphragm 20 may be changed in various ways in terms of shape, material, and thickness.

The voice coil 30 is fixed to a lower surface of the diaphragm 20. The upper end portion of the voice coil 30 is fixed to a lower surface of the boundary portion of the diaphragm 20. The voice coil 30 is formed by winding a wire in an upward direction. The voice coil 30 is electrically connected to a terminal (not shown) included in the frame 10. The voice coil 30 receives a current from an external source thorough the terminal.

A lower portion of the voice coil 30 is positioned in a space between a lateral wall portion of the yoke 50, and the first permanent magnet 60 and the plate 70, which are vertically coupled to each other. The space is referred to as a magnetic gap. When a low-frequency voice signal current flows through the voice coil 30, the voice coil 30 moves up and down due to an interaction between the high frequency current and a magnetic field formed by the first permanent magnet 60. Thus, the diaphragm 20 coupled to the voice coil 30 vibrates to generate a sound.

The first suspension 40 has a predetermined elasticity. An outer circumferential portion of the first suspension 40 is fixed to the frame 10. A suspension may be referred to as an elastic member, a spring, a plate-type spring, or the like. Elasticity is a property of a material that returns to its original volume and shape after an external deformation force is removed, and is classified into volume elasticity and shape elasticity according to the deformation type. According to the present embodiment, the first suspension 40 has mainly shape elasticity.

According to the present embodiment, the first suspension 40 has a plate shape, for example, a disk shape so as to correspond to the shape of the frame 10. The first suspension 40 is formed of plate-shaped metal material such as phosphor bronze. According to another embodiment of the present invention, the first suspension 40 may be formed of a high-molecular weight elastic material. The yoke 50 is fixed to a central portion of the first suspension 40.

The first suspension 40 includes a boss portion 42. The boss portion 42 is formed on the central portion of the first suspension 40. According to the present embodiment, since the first suspension 40 is formed of plate-shaped metal material, the boss portion 42 may be easily manufactured by using various metal processing methods including a press work.

According to the present embodiment, the boss portion 42 has a shape of an unfilled cylinder. That is, a cross section of the boss portion 42 is an unfilled circle. According to another embodiment of the present invention, the boss portion 42 may have various pillar shapes of which cross section is a triangle, a rectangle, a pentagon, an oval, or the like. In addition, an inner portion of the boss portion 42 may be unfilled or filled. If the first suspension 40 is formed of a high-molecular weight elastic material and not of a metal, the boss portion 42 is formed of the same material as the first suspension 40.

A thickness of the boss portion 42 corresponds to a thickness of a yoke receiving groove 52. According to the present embodiment, the thickness of the boss portion 42 may be slightly smaller than a thickness of the yoke 50.

According to the present embodiment, the yoke 50 is fixed to an upper surface of the first suspension 40. The first permanent magnet 60 is coupled to a bottom portion of the yoke 50. The yoke receiving groove 52 to which the boss portion 42 of the first suspension 40 disposed below the yoke 50 is formed in a central portion of the bottom portion. The yoke receiving groove 52 has a shape corresponding to the shape of the boss portion 42 so that the boss portion 42 may be coupled to the yoke receiving groove 52.

According to the present embodiment, since the boss portion 42 has a cylindrical shape, the yoke receiving groove 52 may also have a cylindrical shape so as to correspond to the boss portion 42. A diameter of the yoke receiving groove 52 may be slightly greater than an external diameter of the boss portion 42 so that the boss portion 42 may be firmly coupled to the yoke receiving groove 52 by only inserting the boss portion 42 into the yoke receiving groove 52 without any separate adhesive. The boss portion 42 and the yoke receiving groove 52 may be accurately coupled to each other by inserting the boss portion 42 into the yoke receiving groove 52. If necessary, the boss portion 42 and the yoke receiving groove 52 may be adhered to each other by adhesives.

The first permanent magnet 60 is fixed to the bottom portion of the yoke 50. The first permanent magnet 60 is coupled and fixed to the bottom portion of the yoke 50 by adhesives so as to be concentric to the yoke 50. The first permanent magnet 60 has a disk shape so as to correspond to the shape of the yoke 50.

The plate 70 is fixed to an upper surface of the first permanent magnet 60. The plate 70 is formed of a material through which a magnetic force is smoothly transmitted, and has almost the same diameter as the first permanent magnet 60.

The first permanent magnet 60 and the plate 70 are spaced apart from the lateral wall portion of the yoke 50 and are fixed to the yoke 50. A space is formed between an inner surface of the lateral wall portion of the yoke 50 and external lateral surfaces of the first permanent magnet 60 and the plate 70. The lower portion of the voice coil 30 is disposed in the space.

The first permanent magnet 60, the plate 70, and the yoke 50 constitute a speaker magnetic circuit. That is, a magnetic flux generated by the first permanent magnet 60 forms a magnetic flux path that is transmitted to the yoke 50 through the plate 70.

The second suspension 80 is spaced apart from the first suspension 40 in a downward direction, and is formed of an elastic material. The second suspension 80 includes a supporter 81 and a protrusion 82.

A first end portion of the supporter 81 is fixed to the frame 10. The protrusion 82 protrudes upwards from a second end portion of the supporter 81 towards the first suspension 40.

The protrusion 82 includes a lateral wall portion 84 and a connection 86.

The lateral wall portion 84 extends upwards from the second end portion of the supporter 81. According to the present embodiment, the lateral wall portion 84 extends vertically from the second end portion of the supporter 81.

The connection 86 is disposed in parallel to the first suspension 40. An upper surface of the second magnet 90 described below is fixed to the connection 86. The connection 86 has a disk shape so as to correspond to the shape of the second magnet 90.

According to the present embodiment, the second suspension 80 may be formed of the same material as the first suspension 40. Alternatively, the first suspension 40 and the second suspension 80 may be formed of different materials.

The second magnet 90 is accommodated in the protrusion 82 and is fixed to a lower surface of the second suspension 80. Thus, the second magnet 90 is spaced apart from the first suspension 40 and the yoke 50. According to the present embodiment, the upper surface of the second magnet 90 is fixed to a lower surface of the connection 86 of the second suspension 80. A lateral surface of the second magnet 90 is fixed to the lateral wall portion 84. According to the present embodiment, the lower surface of the second magnet 90 is positioned below the supporter 81. The second magnet 90 may be a permanent magnet, or an electromagnet.

The second magnet 90 and the second suspension 80 constitute a vibrator for generating a vibration. Although the vibrator including the second magnet 90 and the second suspension 80 is spaced apart from the speaker magnetic circuit including the first permanent magnet 60, the plate 70, and the yoke 50, since the vibrator and the speaker magnetic circuit are connected to each other through a magnetic field, a vibration motion of the diaphragm 20 for generating a sound and a vibration motion of the vibrator including the second magnet 90 and the second suspension 80 may minimally interfere with each other.

Hereinafter, the operation and effect of the multifunctional micro speaker 1 will be described.

In the multifunctional micro speaker 1, although the yoke 50, the first permanent magnet 60, and the plate 70 are pulled downwards due to an attractive force between the first permanent magnet 60 and the second magnet 90, the second suspension 80 and the protrusion 82 may prevent the yoke 50, the first permanent magnet 60, and the plate 70 from excessively drooping downwards. Thus, since the voice coil 30 is stably disposed in the magnetic gap, a sound level is stably maintained.

When the second suspension 80 and the second magnet 90 constituting the vibrator vibrate up and down, the second suspension 80 and the second magnet 90 needs to vibrate without any interference with the first suspension 40. According to the present embodiment, the second suspension 80 vibrates up and down with respect to the supporter 81 fixed to the frame 10. In this case, since the supporter 81 and the first suspension 40 are sufficiently spaced apart from each other, the supporter 81 and the first suspension 40 may not interfere with each other during vibration of the first suspension 40 and the second suspension 80, and the protrusion 82 of the second suspension 80 may prevent the first suspension 40 form drooping downwards.

A distance D1 from a center of the connection 86 to the lateral wall portion 84 is greater than a distance D2 from an inner circumference surface of the frame 10. Thus, an area for accommodating the second magnet 90 is increased, thereby ensuring a space for interaction between a current flowing through the voice coil 30 and a magnetic line of force of the second magnet 90.

Since the second magnet 90 is fixed to the protrusion 82 by inserting the second magnet 90 into an internal space of the protrusion 82, it is easy to determine a position of the second magnet 90 during a first process of the second magnet 90, and thus, an assembly process may be effectively performed.

In addition, various modified embodiments of the present invention may be provided.

According to the above-described embodiment of the present invention, the lateral wall portion 84 of the protrusion 82 vertically extends upwards from the supporter 81. Alternatively, the lateral wall portion 84 may extend upwards at a predetermined angle, or may extend with a predetermined curvature.

According to the above-described embodiment of the present invention, the connection 86 has a disk shape. Alternatively, the shape of the connection 86 may be changed in various ways according to the shape of the second magnet 90.

According to the above-described embodiment of the present invention, the boss portion 42 of the first suspension 40 is fixed to the yoke receiving groove 52 by inserting the boss portion 42 into the yoke receiving groove 52. Alternatively, the boss portion 42 may further extend upwards so as to be coupled to the first permanent magnet 60 or the plate 70. In this case, a separate groove or groove may be formed in the first permanent magnet 60 or the plate 70 in order to accommodate the boss portion 42.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multifunctional micro speaker comprising:
a frame;
a diaphragm having an outer circumferential portion fixed to the frame;
a voice coil fixed to a lower surface of the diaphragm;
a first suspension having an outer circumferential portion fixed to the frame and having a predetermined elasticity;
a yoke fixed to the first suspension;
a first permanent magnet fixed to a bottom surface of the yoke;
a plate fixed to an upper surface of the first permanent magnet;
a second suspension comprising a supporter and a protrusion, and having a predetermined elasticity, wherein the supporter is spaced apart from the first suspension in a downwards direction and has a first end portion fixed to the frame, and the protrusion protrudes from the supporter towards the first suspension; and
a second magnet accommodated in the protrusion and fixed to a lower surface of the second suspension.

2. The multifunctional micro speaker of claim 1, wherein the protrusion comprises a lateral wall portion extending upwards from a second end portion of the supporter, and a connection disposed in parallel to the first suspension.

3. The multifunctional micro speaker of claim 2, wherein the connection has a disk shape.

4. The multifunctional micro speaker of claim 2, wherein the lateral wall portion vertically extends upwards from the second end portion of the supporter.

5. The multifunctional micro speaker of claim 1, wherein a lower surface of the second magnet is positioned below the supporter.
